(19) United States
(12) Patent Application Publication
(10) Pub. No.: US 2007/0098427 A1
(43) Pub. Date: May 3, 2007

(54) Image forming device

(76) Inventor: Kenji Katsuhara, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,884

(22) Filed: Oct. 27, 2005

(51) Int. Cl. G03G 15/00; G03G 21/00

(52) U.S. Cl. 399/75; 399/80

(57) ABSTRACT

When a card reader detects that a magnetic card is inserted (YES in S1), an operative program stored in the magnetic card is installed in a storage unit by an installing unit (S3), while when the card reader detects that the magnetic card is removed (YES in S4), the operative control program installed hitherto is uninstalled from the storage unit by an uninstalling unit (S5).

### FIELD OF THE INVENTION

The present invention relates to an image forming device, and more particularly to a technology that allows customizing an operative environment of a device for each operator in a plurality thereof.

### BACKGROUND INFORMATION

Image forming devices installed in offices and used by multiple operators are preferably provided with operative environments that are easy to use for each operator. For instance, in the disclosure of Patent reference 1 is proposed a multi-function machine capable of performing copier functions, fax functions, printer functions, etc., wherein when the modes that each user can use in the multi-function machine are restricted, if a user inputs a keyword via an operating unit, the functions that the user having input the keyword can and cannot use, from among the functions that the multi-function machine can perform, are displayed in a display unit.

However, although such digital multi-function machines make it easy to ascertain the functions for which each user is authorized, they do not allow for improving operability in case the user desires to set up their- own easy-to-use operative environment or set their own desired functions.

With a view of solving the above problems, an object of the present invention is to provide an image forming device that allows for simple customizing of operative settings of the device in accordance with the preferences of any given user in a plurality thereof.

### SUMMARY OF THE INVENTION

The invention recited in claim 1 of the present invention is an image forming device comprising

program storage means for storing an operative control program;

interface means in which an external memory is readably set;

detecting means for detecting whether the external memory is set in the interface means;

installing means for, when the detecting means detects that the external memory is set in the interface means, installing in the program storage means the operative control program stored in the external memory set in the interface means; and

uninstalling means for, once the operative control program stored in the external memory is installed in the program storage means by the installing means, uninstalling from the program storage means the operative control program when the detecting means detects that the external memory is not set in the interface means.

In this constitution, when the external memory is set in the interface means, the operative control program stored in the external memory is installed in the program storage means, and when the external memory is disengaged from the interface means, the operative control program is uninstalled from the program storage means.

The invention recited in claim 2 of the present invention is an image forming device according to claim 1, wherein the external memory stores authentication information for verifying whether use of the image forming device is authorized or not, the image forming device comprising

authentication means for, when the detecting means detects that the external memory is set in the interface means, determining whether authentication information authorizing use of the image forming device is stored or not in the external memory, wherein

when the authentication means decides that authentication information authorizing use of the image forming device is stored in the external memory, the installing means installs in the program storage means the operative control program stored in the external memory.

With this constitution, when the external memory is set in the interface means, if the authentication means decides that authentication information authorizing use of the image forming device is stored in the external memory, the operative control program stored in the external memory is installed in the program storage means.

The invention recited in claim 3 of the present invention is an image forming device according to claim 1, wherein the operative control program installed in the program storage means by the installing means is a program. for controlling a display unit displaying operative guidance, and for controlling processes executed in accordance with operative instructions input on the basis of that display.

With this constitution, the installing means installs in the program storage means an operative control program for controlling a display unit displaying operative guidance, and for controlling processes executed in accordance with operative instructions input on the basis of that display.

By simply setting an external memory in an interface means, the invention recited in claim 1 of the invention allows an operative environment to be set up easily in an image forming device on the basis of an operative control program stored in the external memory. It thus becomes possible to customize the operative settings of the device in accordance with the preferences of each user among a plurality thereof in a simple manner. Also, the operative environment set up hitherto can be easily removed by disengaging the external memory from the interface means. In addition, the storage area of the program storage means can be used efficiently, since the operative control program is uninstalled from the program storage means when the external memory is disengaged from the interface means.

The invention recited in claim 2 allows for precluding changes in the operative environment of the image forming device since, if an external memory not having authentication information for which use of the image forming device is authorized is set in the interface means, the operative control program stored in the external memory is not installed in the program storage means; thus, a holder of an external memory in which authentication information for which use of the image forming device is authorized is not stored, for instance an operator not authorized to use the image forming device, cannot install in the program storage means the operative control program stored in the external memory.

In the invention recited in claim 3, operative guidance displayed on the display unit, and processing of operative instructions input on the basis of this display can be suitably customized in accordance with the content of the operative control program being installed; this allows for suitable customization of the operative guidance displayed on the display unit, and the processes executed according to operative instructions input on the basis of this display, in conformity with the preferences of any given user when there is a plurality thereof.

### BRIEF DESCRIPTION OF THE DRAWINGS

FIG. 1 is a diagram illustrating an external view of the constitution of a multi-function machine which is an embodiment of the present invention.

FIG. 2 is a block diagram schematically illustrating the internal constitution of a multi-function machine according to an embodiment of the present invention.

FIG. 3 is a flowchart illustrating a first embodiment of a process for installing an operative control program read from a magnetic card in a storage unit of a copier.

FIG. 4 is a flowchart illustrating a second embodiment of a process for installing an operative control program read from a magnetic card in a storage unit of a copier.

### DETAILED DESCRIPTION OF THE PREFERRED EMBODIMENTS

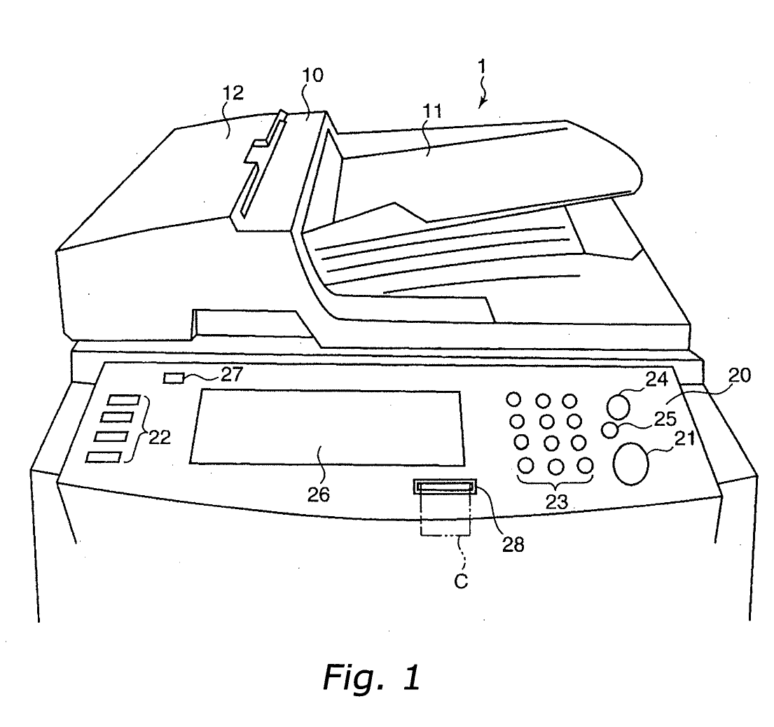

A multi-function machine, which is an embodiment of the image forming device according to the present invention, will be described next with reference to the accompanying drawings. FIG. 1 shows an external view of the constitution of a multi-function machine 1. The multi-function machine 1 comprises a copier function, a fax function, a printer function and a scanner function. On the upper portion of the multi-function machine 1 is provided an automatic document feeder 10 for continuously reading documents when the multi-function machine 1 is used as a fax machine or a copying machine, such that the automatic document feeder 10 can be opened and closed with respect to a glass platen of a scanner unit (not shown). On the upper front portion of the multi-function machine 1 is provided an operating unit 20 in which are arranged various switches for operating the multi-function machine 1.

Documents are loaded on a document loading unit 11 of the automatic document feeder 10; when a start key 21 of the operating unit 20 is turned on, the documents are drawn in succession from the document loading unit 11 into the automatic document feeder 10 through the action of rollers provided in a driving unit 12 of the automatic document feeder 10, are conveyed up to a platen of an image reading unit (scanner), are read by an imaging element (line sensor) such as a CCD, or the like as image data line-by-line in a direction perpendicular to a document transport direction (first scan direction), and are stored in a memory.

The scanner unit has a so-called mirror scan-type optical system and when the automatic document feeder 10 is used for reading documents, the mirror is fixed and the scanner reads documents going past a predetermined position on the platen. On the other hand, when the documents are loaded directly on the platen, without using an automatic document feeder 10, the documents are read through scanning of the mirror in a sub-scan direction perpendicular to the first scan direction, from the lower side of the platen. The scanner unit may be used individually as a scanner, among peripherals of a personal computer, and may send the read image data to a personal computer connected thereto via LAN or the like. Inside the body of the multi-function machine 1 is provided a printing unit (conventional, not shown in the figure) having for instance the constitution of a laser beam printer, etc., or a similar electrophotographic device.

When this multi-function machine 1 is used as a copying machine, the image data read by the scanner unit are output as copies by a recording unit by way of image formation on recording paper by the printing unit. Furthermore, when this multi-function machine 1 is used as a printer connected to a network, the printing unit forms images on recording paper based on print data such as text, images or the like sent by a personal computer connected to the network.

The operating unit 20 of the multi-function machine 1 having the above plurality of functions comprises therefore, besides the start key 21, a function select key 22 for selecting any one among fax, copying machine, printer and scanner functions, a numeric keypad 23 for inputting numbers of copies, fax numbers or the like, a reset key 24 for canceling erroneous inputs, a stop key 25 for discontinuing fax transmissions or printing operations, a display unit 26 consisting of a liquid crystal display or the like and combining a display device for displaying received fax data and/or various selectable functions and an input device (touch panel) for function selection, and a JOB list display key 27 for summarizing on the display unit 26 information relative to received faxes or the like.

In the front panel of the multi-function machine 1 is provided a card reader 28 (interface means, detection means). The card reader 28 is constituted to allow insertion and removal of a portable information recording medium such as a magnetic card C or the like so that data from the magnetic card C is read when it is inserted. The card reader 28 detects the insertion and removal of the portable information recording medium such as the magnetic card C or the like.

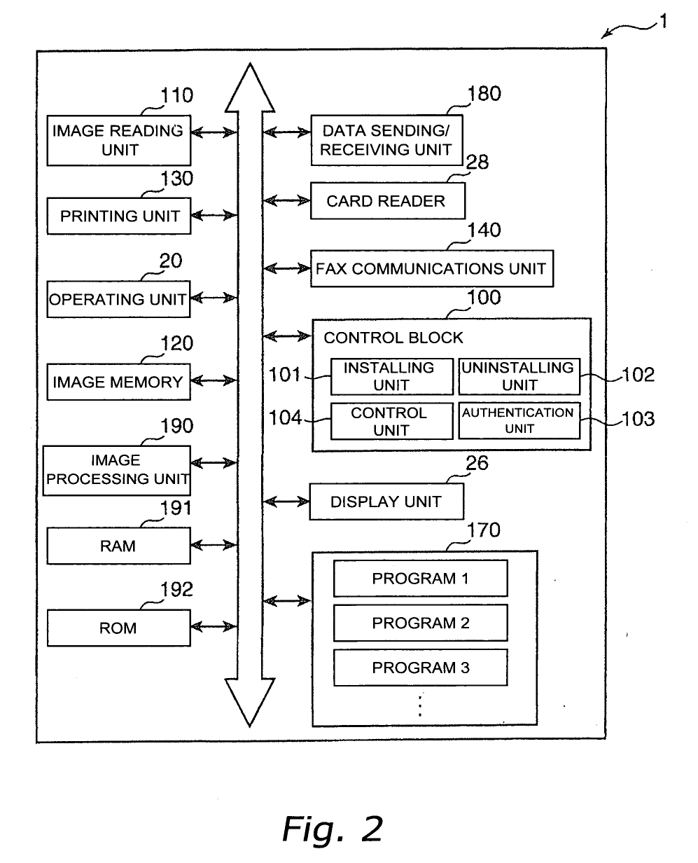

Upon insertion of the magnetic card C, the card reader 28 reads a personal identification code (an example of authentication information) stored in the magnetic card C and sends the read personal identification code to an authentication unit 103 (FIG. 2) described below. The authentication unit 103 determines, among others, whether use of the multi-function machine 1 is authorized for the sent personal identification code, and whether the operative control program stored in the magnetic card C is authorized to be installed in the multi-function machine 1. This personal identification code is an example of authentication information for deciding whether the use of the multi-function machine 1 is allowed or not; all kinds of information employed for deciding on granting or denial of use, such as accounts, passwords, IDs or the like may be suitably used as such authentication information.

The magnetic card C is a magnetic recording medium in which various information can be stored magnetically, for instance a card in which are stored a personal identification code of the card holder, and/or information on the relevant department (information concerning the use of the multi-function machine 1 for use in so-called departmental administration).

Operative control programs stored in the magnetic card C include, for instance, programs for controlling display on the display unit 26 and executing processes in accordance with operative instructions input by an operator on the basis of the display on the display unit 26. Such a program may be a program for (1) creating a ledger, (2) a program for setting in the multi-function machine 1 settings customized by each operator (settings such as recording paper size, density, copy magnification, etc.), a program for (3) using the multi-function machine 1 as a printer or a scanner (or a program for allowing later installation of a program for using the multi-function machine 1 as a printer and/or a scanner, if the multi-function machine 1 is not set up with default settings that allow it to be used as a printer and/or a scanner); also (4) a program and associated destination information for sending data read by an image reading unit 110 to a computer connected to a network, or (5) a program and associated destination address information for implementing an electronic mail transmission function.

In lieu of the magnetic card C, cards consisting of other recording media such as a storage medium using a semiconductor memory, e.g. a flash memory or the like, while the card reader 28 may also be set up as an interface having a constitution corresponding to the storage medium used (i.e., a constitution capable of detecting the loaded storage medium, and capable of reading data from the storage medium). In addition, the card reader 28 may also be set up to allow reading data (programs) from devices used as an external memory, such as notebook personal computers, PDAs, (Personal Digital(Data) Assistants), cellular phones or the like, using interfaces such as USB (Universal Serial Bus), Bluetooth, etc.

FIG. 2 is a block diagram schematically illustrating the internal constitution of the multi-function machine 1 according to an embodiment of the present invention. The multi-function machine 1 has a control block 100 for controlling the operation of the various units of the device, an image reading unit 110 having a scanner or the like for reading document images, an image memory 120 for temporarily storing document image data read by the image reading unit 110 and/or image data read by the image reading unit 110, and a printing unit 130 for printing the document image data, etc. read by the image reading unit 110.

The multi-function machine 1 comprises also a fax communications unit 140 for realizing functions necessary for fax transmission and for receiving image data from external fax devices via a public line; an operating unit 20 consisting of a send start key, a numeric keypad, a speed-dial key, and the like for accepting various operative instructions (number of print copies, etc.) from the operator; and a display unit 26 consisting of an LCD (Liquid Crystal Display) or the like for displaying operative guidance, etc. to the operator.

The multi-function machine 1 further comprises a storage unit 170 (program storage means), consisting of a hard disk or the like, in which various programs can be installed; a RAM 191 used as a work area of a control unit 104, for temporarily storing various data; and a ROM 192 for storing basic programs such as BIOS (basic input/output system) governing the entire operative control of the multi-function machine 1.

The control block 100 comprises an installing unit 101, an uninstalling unit 102, an authentication unit 103 and a control unit 104. When the card reader 28 detects that a magnetic card C is set, the installing unit 101 (installing means) installs in the storage unit 170 the operative control program stored in the magnetic card C. For instance, when a program for ledger creation stored in the magnetic card C is installed in the storage unit 170 by the installing unit 101, the control unit 104 displays on the display unit 26 one or more ledger sheet form names; the operator selects then a desired ledger sheet form among the displayed ledger sheet form names and inputs the required data, and the control unit 104 performs then the ledger sheet creation processing using the selected ledger sheet and the input data, in accordance with the ledger creation program.

The operative control program stored in the magnetic card C and installed in the storage unit 170 by the installing unit 101 is uninstalled from the storage unit 170 by the uninstalling unit 102 when the card reader 28 detects that the magnetic card C is removed.

The authentication unit 103 determines among others whether the use of the multi-function machine 1 is authorized for the personal identification code read from the magnetic card C by the card reader 28. If the authentication unit 103 determines that the authentication information authorizing the use of the image forming device is stored in the external memory, the installing unit 101 installs in the storage unit 170 the operative control program stored in the magnetic card C.

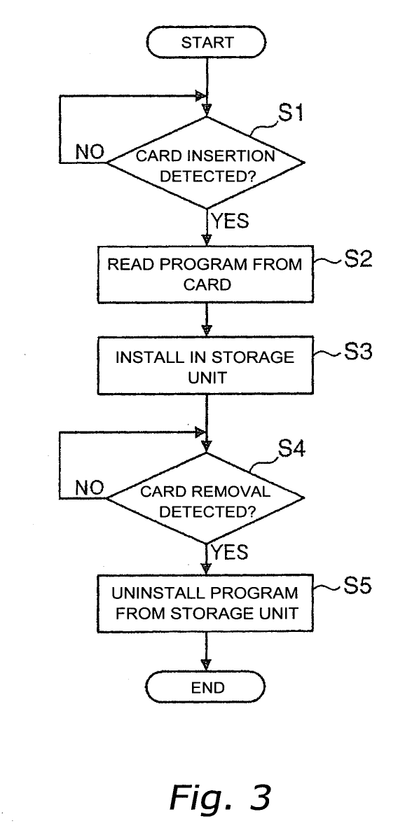

The control unit 104 (control means) governs the entire operative control of the multi-function machine 1. The control unit 104 is constituted so as to execute operative programs installed from the magnetic card C via Java™ or Windows™ (OS). A first embodiment of a process for installing in the storage unit 170 of the multi-function machine 1 an operative control program read from a magnetic card C will be explained now. FIG. 3 is a flowchart illustrating a first embodiment of a process for installing in the storage unit 170 of the multi-function machine 1 an operative control program read from a magnetic card C.

An operator inserts the magnetic card C in the card reader 28; when the card reader 28 detects the insertion of the magnetic card C (YES in S1), the card reader 28 reads an operative control program from the inserted magnetic card C (S2). The installing unit 101 installs in the storage unit 170 the operative control program read by the card reader 28 (S3).

When the operator removes the magnetic card C from the card reader 28 and the card reader 28 detects that the magnetic card C has been removed (YES in S4), the installing unit 101 uninstalls from the storage unit 170 the operative control program installed in S3 (S5).

That is, when the magnetic card C is inserted in the card holder 28, the card holder 28 reads from the magnetic card C an operative control program, and the installing unit 101 installs in the storage unit 170 the read operative control program, so that the operative control program remains installed in the storage unit 170 while the magnetic card C remains inserted in the card reader 28; when the magnetic card C is removed from the card reader 28, the uninstalling unit 102 uninstalls from the storage unit 170 the installed operative control program.

Thus, if in the magnetic card C is stored a customized operative control program for their own use, the operator can then operate the multi-function machine 1 with the customized settings for their own use by inserting the magnetic card C in the card reader 28 of the multi-function machine 1, without any manipulations. Furthermore, when the operator removes the magnetic card C from the card reader 28 once operation is over, the multi-function machine 1 reverts to the original operative settings (the situation before installation of the operative control program from the magnetic card C), which allows another operator to subsequently operate the multi-function machine 1 without experiencing operative malfunctions.

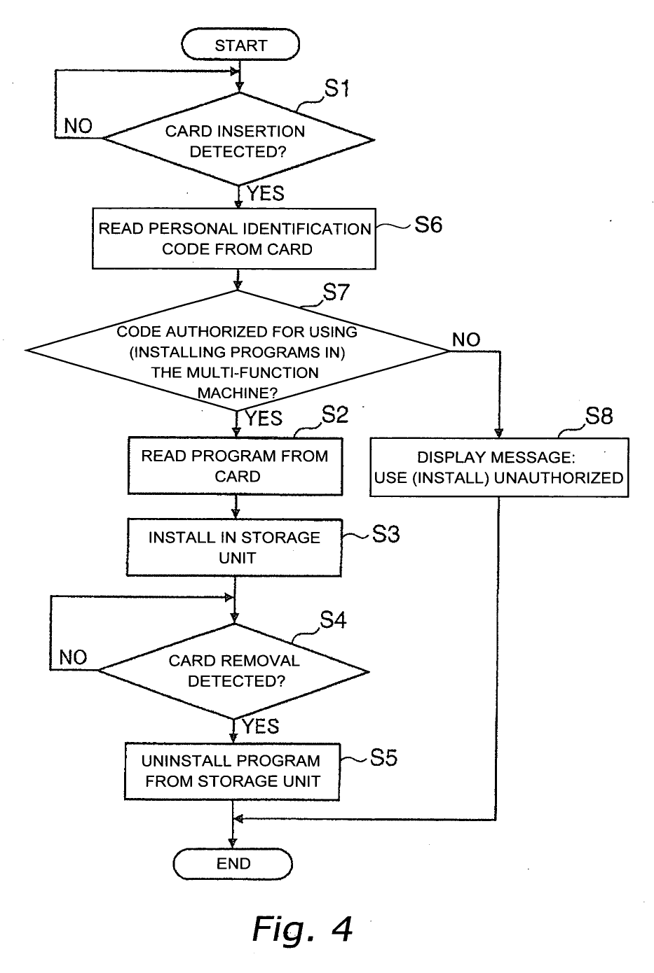

A second embodiment of a process for installing in the storage unit 170 of the multi-function machine 1 an operative control program read from a magnetic card C will be explained next. FIG. 4 is a flowchart illustrating a second embodiment of a process for installing in the storage unit 170 of the multi-function machine 1 an operative control program read from a magnetic card C. Herein, processes identical to those illustrated in the first embodiment of FIG. 1 are denoted with identical reference numerals, and description thereof will be omitted.

In the second embodiment, the operative control program stored in the magnetic card C is not installed in the storage unit 170 unless the personal identification code for which the use of the multi-function machine 1 is authorized is stored in the magnetic card C, even when the magnetic card C is inserted in the card reader 28.

When the operator inserts the magnetic card C in the card reader 28 and the card reader 28 detects the insertion of the magnetic card C (YES in S1), the card reader 28 reads first a personal identification code from the inserted magnetic card C (S6). The authentication unit 103 determines whether the personal identification code read by the card reader 28 matches one or more personal identification codes authorized for using the multi-function machine 1 and which are stored beforehand in the authentication unit 103 (or in the storage unit 170, the ROM 192, etc.) (S7).

If the authentication unit 103 decides that the personal identification code stored in the magnetic card C matches a personal identification code authorized for using the multi-function machine 1 (YES in S7), the installing unit 101 installs in the storage unit 170 the operative control program read from the magnetic card C (S2, S3). If the authentication unit 103 decides that the personal identification code stored in the magnetic card C does not match personal identification codes authorized for using the multi-function machine 1 (NO in S7), the installing unit 101 does not install in the storage unit 170 the operative control program stored in the magnetic card C, and the control unit 104 reports on the display unit 26 that use of the multi-function machine 1 is not authorized, or that the operative control program stored in the magnetic card C cannot be installed.

Authentication of the personal identification code by the authentication unit 103 in S7 may thus be performed by determining whether the personal identification code stored in the magnetic card C is a personal identification code for which use of the multi-function machine 1 is authorized, as explained above; in addition, the operative control program may also be installed by the installing unit 101 only when the personal identification code stored in the magnetic card C and read by the card reader 28 matches a personal identification code for which installation of the operative control program is authorized and which is stored beforehand in the authentication unit 103 (or the storage unit 170, the ROM 192, etc.), as indicated in the bracketed text of S7 in FIG. 4. In this case, the operator that inserted the magnetic card C is allowed to operate the multi-function machine 1 for making copies, etc., but is not allowed to install the operative control program stored in the magnetic card C.

In the above embodiments, the image forming device according to the present invention has been described as the multi-function machine 1; however, the image forming device of the present invention is not limited to a multi-function machine, and may be a single-function device having any function such as a copy machine, a printer, or a fax machine.

In the foregoing embodiments, the constitution and processes of the multi-function machine 1 as illustrated in FIGS. 1 through 4 are given merely by way of example, and are not intended to limit in any way the constitution and processes of the embodiments.

What is claimed is:

1. An image forming device comprising
program storage means for storing an operative control program;
interface means in which an external memory is readably set;
detecting means for detecting whether the external memory is set in the interface means;
installing means for, when the detecting means detects that the external memory is set in the interface means, installing in the program storage means the operative control program stored in the external memory set in the interface means; and
uninstalling means for, once the operative control program stored in the external memory is installed in the program storage means by the installing means, uninstalling from the program storage means the operative control program when the detecting means detects that the external memory is not set in the interface means.

2. An image forming device according to claim 1, wherein the external memory stores authentication information for verifying whether use of the image forming device is authorized or not, the image forming device comprising
authentication means for, when the detecting means detects that the external memory is set in the interface means, determining whether authentication information authorizing use of the image forming device is stored or not in the external memory, wherein
when the authentication means decides that authentication information authorizing use of the image forming device is stored in the external memory, the installing means installs in the program storage means the operative control program stored in the external memory.

3. An image forming device according to claim 1, wherein the operative control program installed in the program storage means by the installing means is a program for controlling a display unit displaying operative guidance, and for controlling processes executed in accordance with operative instructions input on the basis of that display.
